(19) United States
(12) Patent Application Publication
(10) Pub. No.: US 2025/0369917 A1
(43) Pub. Date: Dec. 4, 2025

(54) REUSABLE AIRTIGHT ELECTROCHEMICAL CELL FOR CHARACTERIZATION OF SOLID-STATE MATERIALS

(71) Applicant: Quantum Generative Materials LLC, Austin, TX (US)

(72) Inventors: Young Feng Li, Toronto (CA); Alex Imbault, Sierra Madre, CA (US); Ambrish Kumar, Austin, TX (US)

(21) Appl. No.: 18/731,023

(22) Filed: May 31, 2024

(51) Int. Cl. G01N 27/406; G01N 27/416

(52) U.S. Cl. CPC G01N 27/406; G01N 27/4166

(57) ABSTRACT

The disclosed apparatus comprises a substantially optically clear glass tube configured for the introduction of solid-state materials. A piston is inserted into each end of the glass tube, which is compressed inward via a securing spring positioned between the back of the piston head and an end cap threaded over the glass tube's threads to press down on an O-ring (or septum or gasket) to ensure an airtight seal, and configured to apply a controllable pressure to compress the solid-state materials. An O-ring is in contact with each of the pistons to seal the glass tube. The apparatus is configured for in-situ testing of the solid-state materials and visualizing the solid-state material. Data from the solid-state materials is received via the electrically conductive interface of the pistons, which are constructed of copper. The apparatus is designed to be reusable.

### FIELD OF THE INVENTION

The present disclosure generally relates to the field of electrochemical characterization tools, and more specifically, to a reusable and airtight electrochemical cell for the characterization of solid-state materials.

### BACKGROUND

Conventionally, electrochemical cells include devices that convert chemical energy into electrical energy, or vice versa, through redox reactions. They are widely used in various applications, including batteries, fuel cells, and sensors. In a typical electrochemical cell, an anode and a cathode are separated by an electrolyte, which allows ions to move between the electrodes, facilitating the redox reactions. Solid-state materials, including solid-state electrolytes, have gained increasing attention in the field of electrochemical cells due to their potential advantages over liquid or gel electrolytes, such as improved safety, higher energy density, improves lifespan, and wider operating temperature range. Solid-state electrolytes are typically composed of inorganic or organic materials that can conduct ions at room temperature or higher.

Characterization of solid-state materials, particularly solid-state electrolytes, is a pivotal step in the development of electrochemical cells. It involves the measurement of various properties of the materials, such as ionic conductivity, electronic conductivity, and electrochemical stability. These properties can greatly affect the performance of electrochemical cells.

Traditionally, characterization of solid-state materials is performed using various techniques, such as impedance spectroscopy, cyclic voltammetry, and differential scanning calorimetry. These techniques often require specialized equipment and can be time-consuming and resource-intensive. Furthermore, they typically involve the use of disposable cells, which can be wasteful and not conducive to high-throughput studies. In addition to these techniques, real-time in-vitro visual inspection of the solid-state materials can also provide valuable information about their properties. However, conventional electrochemical cells often do not simultaneously allow for visual inspection due to their opaque housing, easy assembly and disassembly, and reusability.

As such, there is thus a need for addressing these and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to an apparatus, including: a glass tube configured for introduction of solid-state materials and substantially optically clear; a piston inserted into each end of the glass tube configured to apply a controllable pressure to compress the solid-state materials; an O-ring in contact with each of the pistons to seal the glass tube; an end cap in contact with the O-ring and threaded onto the glass tube, configured to create an inert atmosphere for solid-state testing; and each of the pistons includes an electrically conductive interface.

In some aspects, the techniques described herein relate to an apparatus, wherein the apparatus is configured for in-situ testing of the solid-state materials.

In some aspects, the techniques described herein relate to an apparatus, wherein the apparatus is configured for receiving data from the solid-state materials.

In some aspects, the techniques described herein relate to an apparatus, wherein each of the pistons is constructed of copper.

In some aspects, the techniques described herein relate to an apparatus, wherein the glass tube is a closed-system.

In some aspects, the techniques described herein relate to an apparatus, wherein the apparatus is configured to be reusable.

In some aspects, the techniques described herein relate to an apparatus, wherein the apparatus is configured to visualize the solid-state material.

In some aspects, the techniques described herein relate to an apparatus, wherein the apparatus is configured for in-situ testing or to promote reproducibility of the solid-state materials.

In some aspects, the techniques described herein relate to an apparatus, wherein the apparatus is configured for receiving data from the solid-state materials via the electrically conductive interface of the pistons.

In some aspects, the techniques described herein relate to an apparatus, wherein the data is obtained via a potentiostat.

In some aspects, the techniques described herein relate to an apparatus, wherein the apparatus is configured to be reusable.

In some aspects, the techniques described herein relate to an apparatus, wherein the apparatus is configured to visualize the solid state material during in-situ testing.

In some aspects, the techniques described herein relate to an apparatus, wherein the visualization includes detection of visual disintegration, separation, boundary line separation, or discoloration of the solid state material.

In some aspects, the techniques described herein relate to a method, including: introducing solid-state materials into an optically-clear glass tube; applying a controllable pressure to compress the solid-state materials using a piston inserted into each end of the glass tube, wherein each of the pistons is configured to have an electrically conductive interface; and creating an inert atmosphere conducive for solid-state testing via an O-ring in contact with an end cap and each of the pistons.

In some aspects, the techniques described herein relate to a method, further including testing in-situ the solid-state materials.

In some aspects, the techniques described herein relate to a method, further including receiving data from the solid-state materials.

In some aspects, the techniques described herein relate to a method, wherein the data includes at least one of electrochemical activity, current responses, cyclic voltammetry, or impedance spectroscopy.

In some aspects, the techniques described herein relate to a method, further including visualizing the solid-state materials during in-situ testing.

In some aspects, the techniques described herein relate to a method, further including reusing the glass tube for a second set of solid-state materials.

In some aspects, the techniques described herein relate to a method, further including causing reproducibility of the solid-state materials.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates an exemplary fully assembled electrochemical cell, according to aspects of the present disclosure.

FIG. 2 depicts a method for assembling the electrochemical cell for testing solid-state materials, in accordance with aspects of the present disclosure.

FIG. 3A provides a detailed view of the individual components of the electrochemical cell, as per aspects of the present disclosure.

FIG. 3B provides detailed views of pistons in action within the electrochemical cell, as per aspects of the present disclosure.

FIG. 3C provides a side view of the electrochemical cell, as per aspects of the present disclosure.

FIG. 3D provides detailed views of pistons with securing springs installed in action within the electrochemical cell, as per aspects of the present disclosure.

FIG. 3E provides a side view of the electrochemical cell with securing springs installed, as per aspects of the present disclosure.

FIG. 4 illustrates a collection of possible industrial applications of solid-state electrolyte ionic conductivity maximization, in accordance with one embodiment.

FIG. 5 illustrates a network architecture, in accordance with one possible embodiment.

FIG. 6 illustrates an exemplary system, in accordance with one embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to an apparatus for testing solid-state materials. In particular, the present disclosure may provide an apparatus that allows for the introduction, compression, and testing of solid-state materials in an inert atmosphere at varying temperatures. This apparatus may include a glass tube, pistons, securing springs, O-rings, and end caps, and may be configured to be substantially optically clear, allowing for visual inspection of the solid-state materials during testing.

In some aspects, the apparatus may be configured for in-situ testing of the solid-state materials. The apparatus may include pistons inserted into each end of the glass tube, held in place by securing springs positioned between the back of the piston head and an end cap, which may be configured to apply a controllable pressure to compress the solid-state materials. The O-rings may be in contact with each of the pistons and secured in place with end caps to seal the glass tube, creating an inert atmosphere at varying temperatures conducive for solid-state testing.

In some cases, the pistons may include an electrically conductive interface, allowing for the receiving of data from the solid-state materials. The data may be obtained via a potentiostat, providing valuable information about the properties and performance of the solid-state materials.

In other aspects, the apparatus may be configured to be reusable, providing a cost-effective and environmentally friendly solution for testing solid-state materials. The apparatus may also be non-destructively disassembled, allowing for easy replacement of the solid-state materials, and facilitating high-throughput studies.

Furthermore, the apparatus may be configured to visualize the solid-state material, allowing for real-time observation of the material during testing. This may include detection of visual disintegration, separation, boundary line separation, or discoloration of the solid-state material, providing valuable insights into the behavior and performance of the material under different conditions.

In summary, there is a continuous demand for improved tools and methods for the characterization of solid-state materials in the field of electrochemical cells. These tools and methods ideally would allow for easy assembly and disassembly, reusability, reproducibility of test materials, and visual inspection of the materials, while maintaining the ability to accurately measure their properties. The present disclosure therefore provides an apparatus that allows for efficient, effective, and versatile testing of solid-state materials, offering numerous advantages over existing testing methods and devices.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTION OF EXEMPLARY EMBODIMENTS

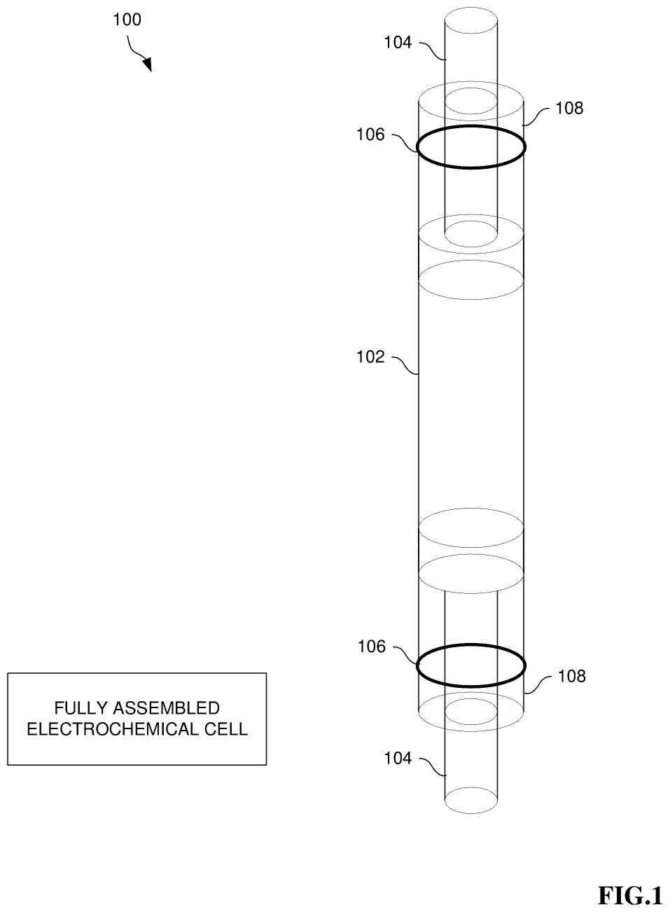

FIG. 1 illustrates an exemplary fully assembled electrochemical cell 100, in accordance with one embodiment. As an option, the cell 100 may be implemented in the context of any one or more of the embodiments set forth in any previous and/or subsequent figure(s) and/or description thereof. Of course, however, the cell 100 may be implemented in the context of any desired environment. Further, the aforementioned definitions may equally apply to the description below.

The cell 100 includes a glass tube 102 configured for the introduction of solid-state materials. In some aspects, the glass tube 102 may be substantially optically clear, allowing for visual inspection of the solid-state materials during testing. This visual inspection can include detection of visual disintegration, separation, boundary line separation, or discoloration of the solid-state material, providing valuable insights into the behavior and performance of the material under different conditions.

The cell 100 further includes pistons 104 inserted into each end of the glass tube 102. The pistons 104 may be configured to apply a controllable pressure to compress the solid-state materials. In some cases, the pistons 104 may include an electrically conductive interface, allowing for the receiving of data from the solid-state materials. The data may be obtained via a potentiostat, providing valuable information about the properties and performance of the solid-state materials.

In various embodiments, the data from the solid-state material may include electrochemical activity such as voltage or potential measurements (such as that which are obtained to analyze redox reactions occurring within the material). Current responses may be measured to determine conductivity or resistance. Further, cyclic voltammetry and impedance spectroscopy may be utilized to further elucidate electrochemical behavior and interfacial processes. Additionally, electrochemical cycling experiments may be used to assess long-term stability and performance. The capabilities of having a visual inspection of the solid-state material may be especially useful in conducting cycling experimentation. Further, surface analysis techniques may provide spatially resolved data on surface reactivity and morphology of the solid-state materials. It is recognized that other data may be obtained relating to the solid-state materials (chronoamperometry, chronopotentiometry, galvanostatic cycling, electrochemical frequency modulation (EFM), electrochemical noise analysis (ENA), etc.). Regardless, a focus of the present disclosure is on having an inert environment for testing the solid-state materials, and for obtaining the data relating to such testing. As such, it is anticipated that other testing to obtain other data may be possible using the techniques and apparatus disclosed herein.

The cell 100 also includes O-rings 106 in contact with each of the pistons 104. The O-rings 106 may be configured to seal the glass tube 102. In one aspect, O-rings 106 may be alternatively incorporated into the cell 100 as septa or gaskets. In some aspects, the cell 100 may be configured to be reusable, providing a cost-effective and environmentally friendly solution for testing solid-state materials. In a related aspect, the cell 100 may be configured wherein end caps 108 may be used to enclose the pistons 104 into a closed system, creating an inert atmosphere for solid-state testing. Further, the closed system may be modified at varying temperatures conducive for the solid-state testing. The cell 100 may also be non-destructively disassembled, allowing for easy replacement of the solid-state materials and facilitating high-throughput studies.

In some embodiments, the cell 100 may be configured for in-situ testing of the solid-state materials. This may involve the use of a heating element wrapped around the body of the cell to control the temperature during testing. The arms of the metal pistons 104 on either side may protrude from the end caps 108 and may be connected to electrochemical testing equipment.

In other embodiments, one piston 104 may function as an anode and the other piston 104 may function as a cathode by contacting with various anode and cathode materials, respectively, thus allowing for discharge cycling. This configuration may enable the cell 100 to function as a full battery, providing further opportunities for testing and analysis of the solid-state materials.

In summary, the cell 100 provides a versatile and efficient solution for testing solid-state materials, offering numerous advantages over existing testing methods and devices. The cell 100 allows for the introduction, compression, and testing of solid-state materials in an inert atmosphere at varying temperatures, and enables visual inspection of the materials during testing. The cell 100 is also reusable and can be non-destructively disassembled, facilitating high-throughput studies and providing a cost-effective and environmentally friendly solution.

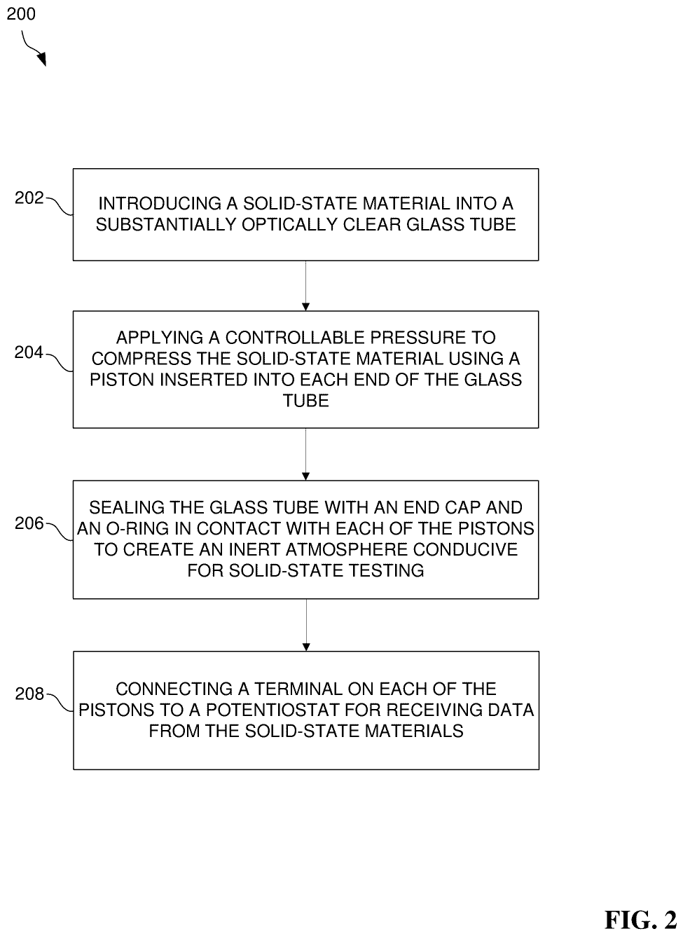

FIG. 2 illustrates a method 200 for assembling the electrochemical cell for testing solid-state materials, in accordance with one embodiment. As an option, the method 200 may be implemented in the context of any one or more of the embodiments set forth in any previous and/or subsequent figure(s) and/or description thereof. Of course, however, the method 200 may be implemented in the context of any desired environment. Further, the aforementioned definitions may equally apply to the description below.

In some aspects, the method may begin with the introduction of solid-state materials into the glass tube 102 of the cell 100. The pistons 104 may then be inserted into each end of the glass tube 102, applying a controllable pressure to compress the solid-state materials.

In some cases, the pistons 104 may include an electrically conductive interface, allowing for the receiving of data from the solid-state materials. The data may be obtained via a potentiostat, providing valuable information about the properties and performance of the solid-state materials.

The inner diameter of the O-rings 106 may be in contact with each of the pistons 104, sealing the glass tube 102 and creating an inert atmosphere at varying temperatures conducive for solid-state testing. In some aspects, the cell 100 may be configured to be reusable, providing a cost-effective and environmentally friendly solution for testing solid-state materials.

In other aspects, the cell 100 may be configured for in-situ testing of the solid-state materials. This may involve the use of a heating element wrapped around the body of the cell to control the temperature during testing. The arms of the metal pistons 104 on either side may protrude from the end caps 108 and can be connected to electrochemical testing equipment.

In some embodiments, one piston 104 may function as an anode and the other piston 104 may function as a cathode, allowing for discharge cycling. This configuration may enable the cell 100 to function as a full battery, providing further opportunities for testing and analysis of the solid-state materials. It is to be appreciated that the pistons may be configured to function as an electrode, or be coated with a surface layer to enable functioning as an electrode.

In summary, the method provides a versatile and efficient solution for testing solid-state materials, offering numerous advantages over existing testing methods. The method allows for the introduction, compression, and testing of solid-state materials in an inert atmosphere at varying temperatures, and enables visual inspection of the materials during testing. The method is also reusable and can be non-destructively disassembled, facilitating high-throughput studies and providing a cost-effective and environmentally friendly solution.

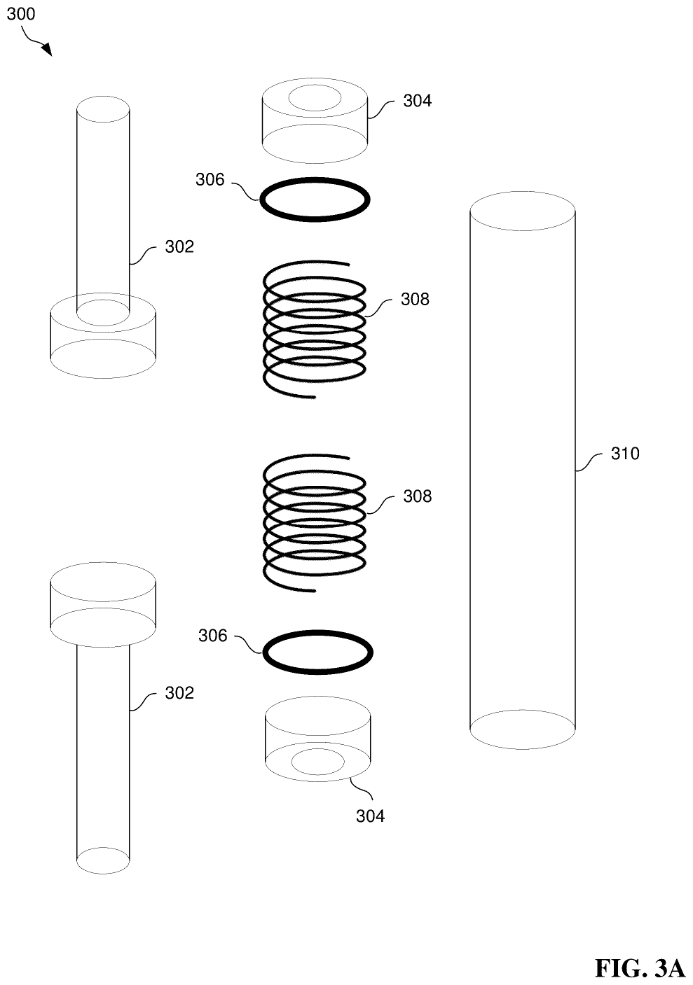

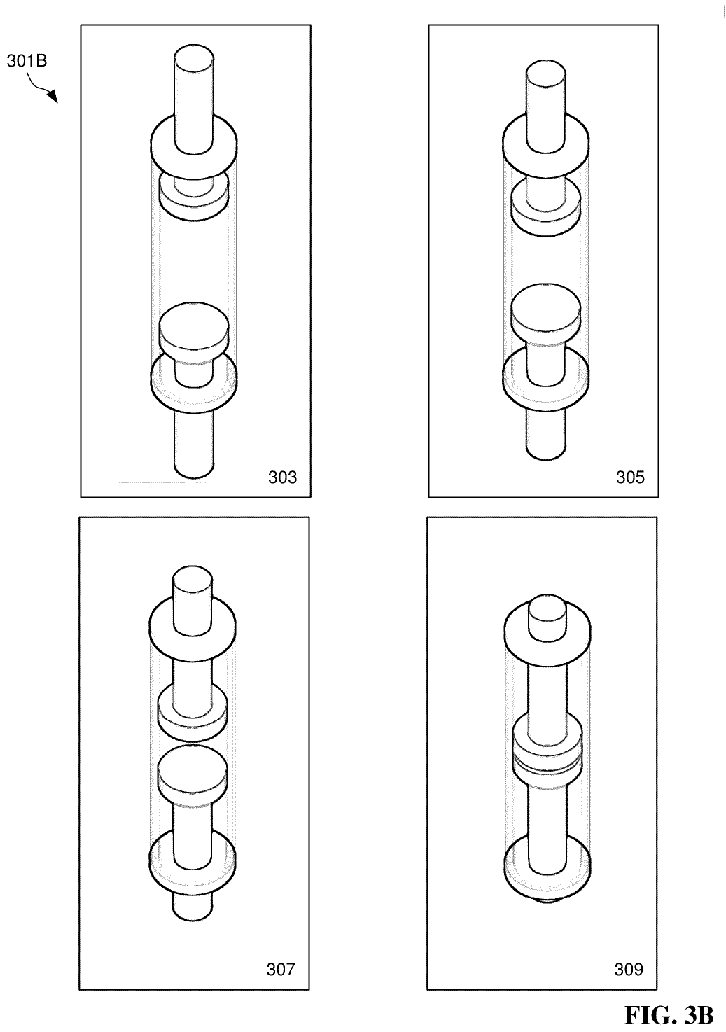

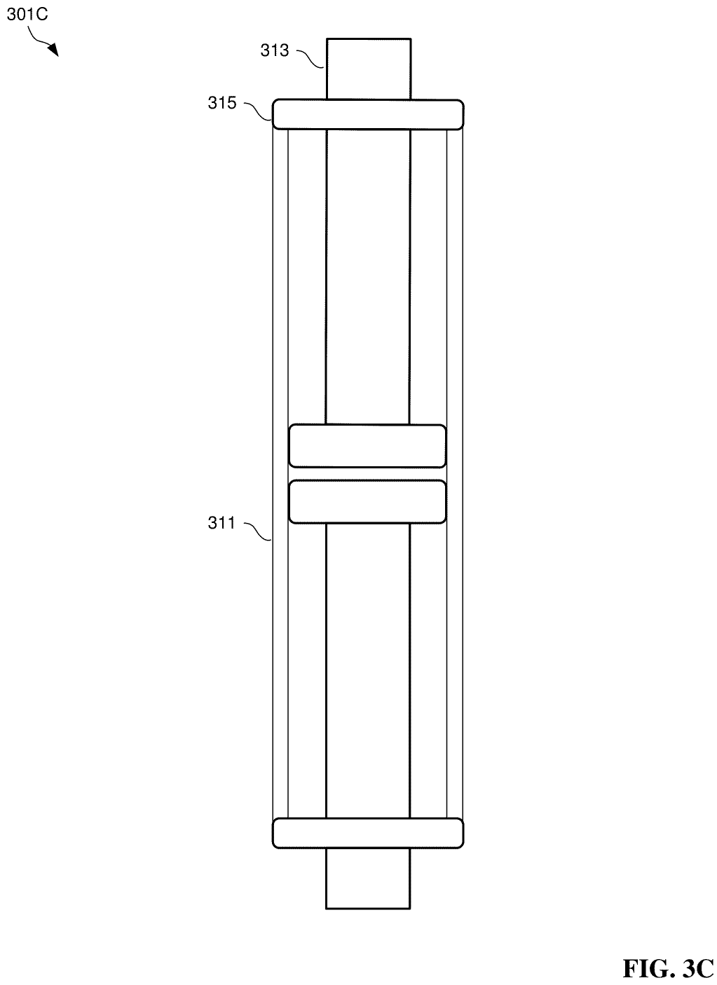

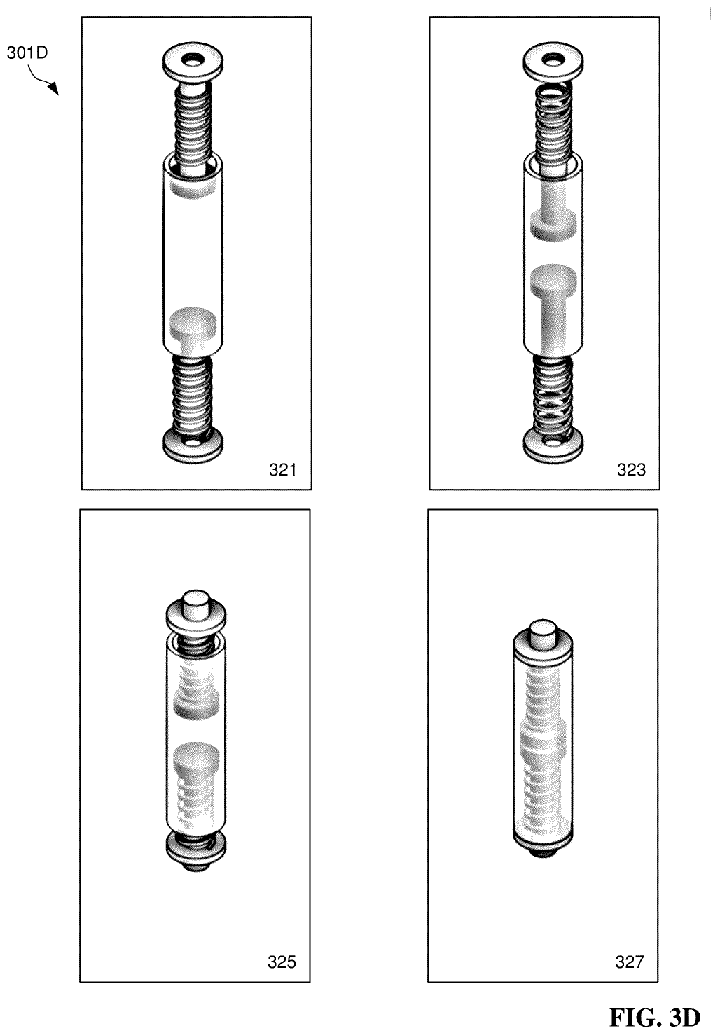

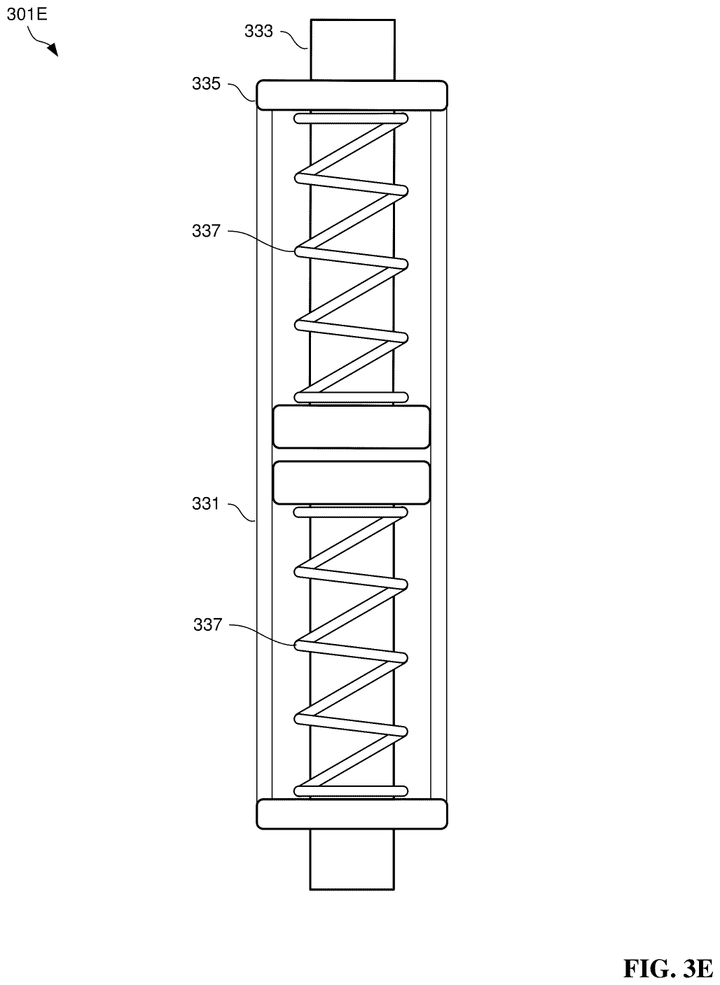

FIG. 3A illustrates a detailed view of the individual components 300 of the electrochemical cell, in accordance with one embodiment. As an option, the components 300 may be implemented in the context of any one or more of the embodiments set forth in any previous and/or subsequent figure(s) and/or description thereof. Of course, however, the components 300 may be implemented in the context of any desired environment. Further, the aforementioned definitions may equally apply to the description below.

The glass tube 310 (i.e. glass body) of the electrochemical cell is configured for the introduction of solid-state materials. In some aspects, the glass tube 310 may be substantially optically clear, allowing for visual inspection of the solid-state materials during testing.

The cell 100 further includes an O-ring 306, which may press against the opening of the glass thread and the end cap 304. The opening may allow the metal piston electrode/current-collector 302 to slide through. Upon compression induced by the end caps, the opening may contract, forming an airtight seal with the metal piston electrode/current-collector 302.

The end cap 304, with an opening on both sides, may be configured to thread onto the glass tube 310 and squeeze down on the O-ring 306, while also allowing the metal piston electrode/current-collector 302 to pass through.

In some cases, the metal piston electrode/current-collector 302 may be constructed of copper, providing high electrical conductivity for the solid-state materials. In other cases, the metal piston electrode/current-collector 302 may be constructed of other electrically conductive materials.

In some aspects, the cell 100 may be configured to be reusable, providing a cost-effective and environmentally friendly solution for testing solid-state materials. The cell 100 may also be non-destructively disassembled, allowing for easy replacement of the solid-state materials and facilitating high-throughput studies.

Furthermore, the cell 100 may be configured to visualize the solid-state material, allowing for real-time observation of the material during testing. This may include detection of visual disintegration, separation, boundary line separation, or discoloration of the solid-state material, providing valuable insights into the behavior and performance of the material under different conditions.

In summary, the components of the cell 100 provide a versatile and efficient solution for testing solid-state materials, offering numerous advantages over existing testing methods and devices. The components allow for the introduction, compression, and testing of solid-state materials in an inert atmosphere at varying temperatures, and enable visual inspection of the materials during testing. The components are also reusable and can be non-destructively disassembled, facilitating high-throughput studies and providing a cost-effective and environmentally friendly solution.

A number of implementations have been described. Nevertheless, it will be understood that various modifications may be made without departing from the spirit and scope of the disclosure. Accordingly, other implementations are within the scope of the following claims.

FIG. 3B illustrates detailed views 301B of pistons in action within the electrochemical cell, as per aspects of the present disclosure. As an option, the detailed views 301B may be implemented in the context of any one or more of the embodiments set forth in any previous and/or subsequent figure(s) and/or description thereof. Of course, however, the detailed views 301B may be implemented in the context of any desired environment. Further, the aforementioned definitions may equally apply to the description below.

As shown, the detailed views 301B show the electrochemical cell with the pistons in a variety of positions of action. For example, representation 303 shows the pistons in a first position near end caps or walls of the glass tube, whereas representation 309 shows the pistons in a second position near a compressed state (where each piston is near the other piston). Representations 305 and 307 display various other positions of the pistons in various positions of compression.

The detailed views 301B show active compression and testing of solid state materials. Additionally, the detailed views 301B provides a visual inspection of the pistons, and the solid-state materials within the glass tube. It is to be recognized that the solid-state materials are not explicitly shown within the glass tube (throughout the disclosure), but it is to be appreciated that any solid-state material, as discussed herein, can be used within the context of present disclosure. In this manner, as the pistons are engaged and compressed, various properties of the materials may be measured.

FIG. 3C illustrates a side view 301C of the electrochemical cell, in accordance with one embodiment. As an option, the side view 301C may be implemented in the context of any one or more of the embodiments set forth in any previous and/or subsequent figure(s) and/or description thereof. Of course, however, the side view 301C may be implemented in the context of any desired environment. Further, the aforementioned definitions may equally apply to the description below.

As shown, the side view 301C is shown as an alternative view to the cell 100 discussed hereinabove. For example, the side view 301C includes a glass tube 311, pistons 313, and O-rings 315. The discussion, as it relates to the cell 100, applies equally to the side view 301C.

FIG. 3D illustrates detailed views 301D of pistons with securing springs installed in action within the electrochemical cell, as per aspects of the present disclosure. As an option, the detailed views 301D may be implemented in the context of any one or more of the embodiments set forth in any previous and/or subsequent figure(s) and/or description thereof. Of course, however, the detailed views 301D may be implemented in the context of any desired environment. Further, the aforementioned definitions may equally apply to the description below.

As shown, the detailed views 301D show the electrochemical cell with the pistons and the securing springs in a variety of positions of action. For example, representation 321 shows the pistons in a first position near end caps or walls of the glass tube, whereas representation 327 shows the pistons in a second position near a compressed state (where each piston is near the other piston). Representations 323 and 325 display various other positions of the pistons and the securing springs in various positions of compression.

The detailed views 301D show active compression and testing of solid state materials. Additionally, the detailed views 301D provides a visual inspection of the pistons, and the solid-state materials within the glass tube. It is to be recognized that the solid-state materials are not explicitly shown within the glass tube (throughout the disclosure), but it is to be appreciated that any solid-state material, as discussed herein, can be used within the context of present disclosure. In this manner, as the pistons are engaged and compressed, various properties of the materials may be measured.

FIG. 3E illustrates a side view 301E of the electrochemical cell, in accordance with one embodiment. As an option, the side view 301E may be implemented in the context of any one or more of the embodiments set forth in any previous and/or subsequent figure(s) and/or description thereof. Of course, however, the side view 301E may be implemented in the context of any desired environment. Further, the aforementioned definitions may equally apply to the description below.

As shown, the side view 301E is shown as an alternative view to the cell 100 discussed hereinabove. For example, the side view 301E includes a glass tube 331, pistons 333, O-rings 335, and securing springs 337. The discussion, as it relates to the cell 100, applies equally to the side view 301E, with the primary addition being the securing springs 337.

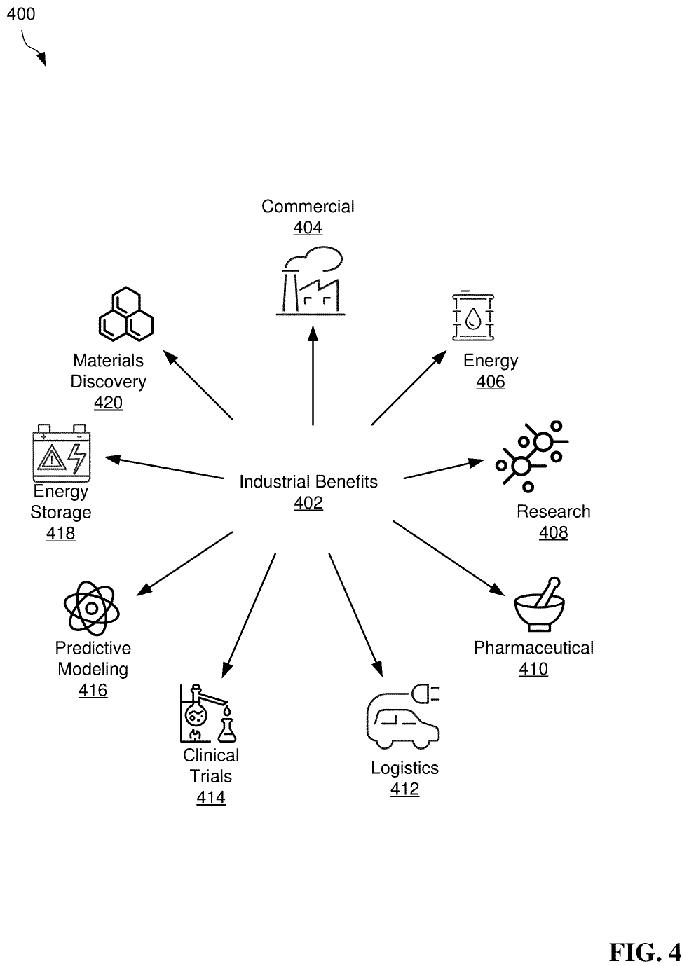

FIG. 4 illustrates a collection 400 of possible industrial applications of solid-state electrolyte ionic conductivity maximization, in accordance with one embodiment. As an option, the collection 400 may be implemented in the context of any one or more of the embodiments set forth in any previous and/or subsequent figure(s) and/or description thereof. Of course, however, the collection 400 may be implemented in the context of any desired environment. Further, the aforementioned definitions may equally apply to the description below.

As shown, industrial benefits 402 may include commercial 404, energy 406, research 408, pharmaceutical 410, logistics 412, clinic trials 414, predictive modeling 416, energy storage 418, materials discovery 420, etc. It is to be appreciated that any industrial benefit 402 shown is merely exemplary and should not be limiting to the disclosure herein in any manner.

Further, the collection 400 is intended to represent the wide applicability of the present disclosure to a variety of industries. Materials, at a global context level, relates to every human throughout the world. As such, generation of novel materials may affect all industries worldwide.

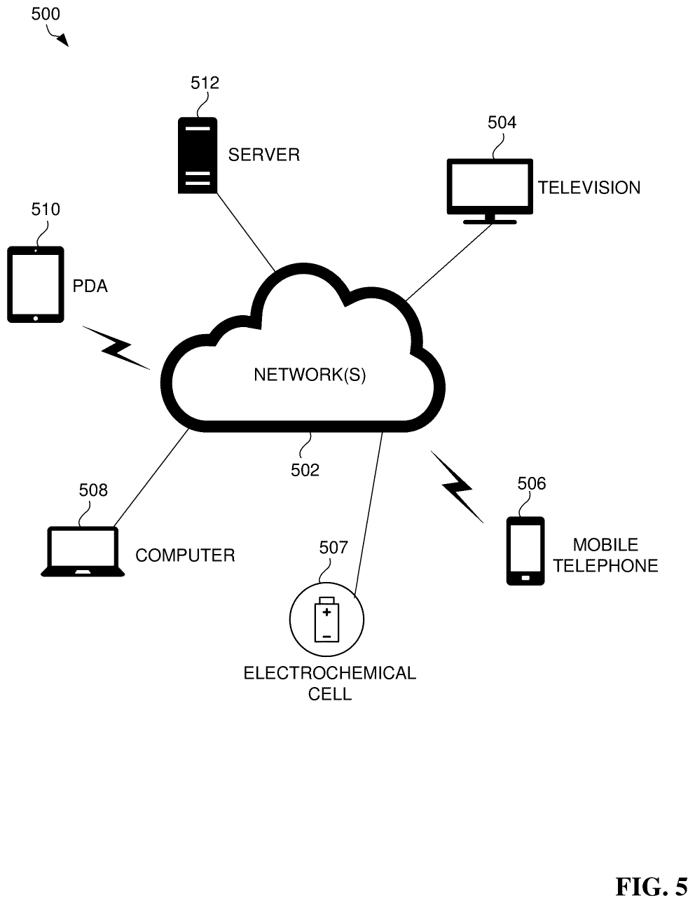

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 512 and an end user computer 508 may be coupled to the network 502 for communication purposes. Such end user computer 508 may include a desktop computer, lap-top computer, and/or any other type of logic. Still yet, various other devices may be coupled to the network 502 including a personal digital assistant (PDA) device 510, a mobile telephone 506, a television 504, etc. Further still, and with particular relevancy to the context of the present description, an electrochemical cell 507 may be coupled to the network 502 and/or any other device.

For example, the electrochemical cell 507 may be configured to report measurements to another device (e.g. the computer 508, the mobile telephone 506, etc.). Further, it is acknowledged that the electrochemical cell 507 may be configured to connect directly to another device (e.g. the computer 508, the mobile telephone 506, etc.) without having to go through the network 502.

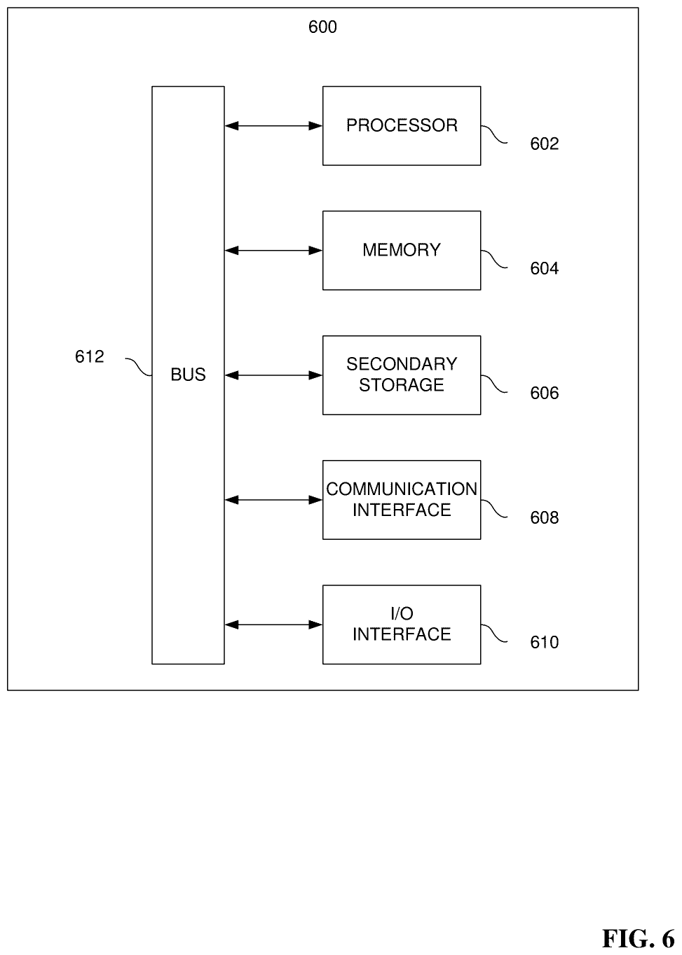

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 602 which is connected to a communication bus 612. The system 600 also includes main memory 604 [e.g., random access memory (RAM), etc.]. The system 600 also includes a graphics processor 608 and a display 610.

The system 600 may also include a secondary storage 606. The secondary storage 606 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 604, the secondary storage 606, and/or any other memory, for that matter. Such computer programs, when executed, enable the system 600 to perform various functions (as set forth above, for example). Memory 604, storage 606 and/or any other storage are possible examples of non-transitory computer-readable media. It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “and” “a” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An apparatus, comprising:
a glass tube configured for introduction of solid-state materials and substantially optically clear;
a piston inserted into each end of the glass tube configured to apply a controllable pressure to compress the solid-state materials;
an O-ring in contact with each of the pistons to seal the glass tube;
an end cap in contact with the O-ring and threaded onto the glass tube, configured to create an inert atmosphere for solid-state testing; and
each of the pistons includes an electrically conductive interface.

2. The apparatus of claim 1, wherein the apparatus is configured for in-situ testing of the solid-state materials.

3. The apparatus of claim 1, wherein the apparatus is configured for receiving data from the solid-state materials.

4. The apparatus of claim 1, wherein each of the pistons is constructed of copper.

5. The apparatus of claim 1, wherein the glass tube is a closed-system.

6. The apparatus of claim 1, wherein the apparatus is configured to be reusable.

7. The apparatus of claim 1, wherein the apparatus is configured to visualize the solid-state material.

8. The apparatus of claim 1, wherein the apparatus is configured for in-situ testing or to promote reproducibility of the solid-state materials.

9. The apparatus of claim 2, wherein the apparatus is configured for receiving data from the solid-state materials via the electrically conductive interface of the pistons.

10. The apparatus of claim 9, wherein the data is obtained via a potentiostat.

11. The apparatus of claim 8, wherein the apparatus is configured to be reusable.

12. The apparatus of claim 8, wherein the apparatus is configured to visualize the solid state material during in-situ testing.

13. The apparatus of claim 12, wherein the visualization includes detection of visual disintegration, separation, boundary line separation, or discoloration of the solid state material.

14. A method, comprising:
introducing solid-state materials into an optically-clear glass tube;
applying a controllable pressure to compress the solid-state materials using a piston inserted into each end of the glass tube, wherein each of the pistons is configured to have an electrically conductive interface; and
creating an inert atmosphere conducive for solid-state testing via an O-ring in contact with an end cap and each of the pistons.

15. The method of claim 14, further comprising testing in-situ the solid-state materials.

16. The method of claim 14, further comprising receiving data from the solid-state materials.

17. The method of claim 16, wherein the data comprises at least one of electrochemical activity, current responses, cyclic voltammetry, or impedance spectroscopy.

18. The method of claim 14, further comprising visualizing the solid-state materials during in-situ testing.

19. The method of claim 14, further comprising reusing the glass tube for a second set of solid-state materials.

20. The method of claim 14, further comprising causing reproducibility of the solid-state materials.
